(19) United States
(12) Patent Application Publication
(10) Pub. No.: US 2009/0177612 A1
(43) Pub. Date: Jul. 9, 2009

(54) Method and Apparatus for Analyzing Data to Provide Decision Making Information

(75) Inventor: Richard Alan GORHAM, Laguna Beach, CA (US)

Correspondence Address: CROWELL & MORING LLP;INTELLECTUAL PROPERTY GROUP, P.O. BOX 14300, WASHINGTON, DC, 20044-4300, US

(73) Assignee: VALUE CREATION INSTITUTE, Laguna Hills, CA (US)

(21) Appl. No.: 12/349,111

(22) Filed: Jan. 6, 2009

Related U.S. Application Data
(60) Provisional application No. 61/019,801, filed on Jan. 8, 2008.

(51) Int. Cl. G06N 7/02

(52) U.S. Cl. 706/52

(57) ABSTRACT

Method and apparatus for analyzing data to provide decision making information. In one embodiment, a method includes receiving data corresponding to an agent for one or more predictor variables of a model, and calculating coefficients of the model based, at least in part, on a logistic regression analysis for a response variable to determine probability densities of the response variable, wherein the response variable is associated with the one or more predictor variables. The method may further include performing a computational analysis of the response variable based on the probability densities of the response variable to determine variation in the probability densities of the response variable, and generating a decision matrix, reflecting probabilities of one or more response variables and analysis values.

### CROSS-REFERENCE TO RELATED APPLICATION

This application claims the benefit of U.S. provisional Application No. 61/019,801 filed Jan. 8, 2008.

### FIELD OF THE INVENTION

The present invention relates in general to data analysis and more particularly to a method and apparatus employing one or more of a logistical regression, computational analysis, and decision matrix into a visual analysis tool.

### BACKGROUND

Conventional systems and devices for statistical analysis typically employ computing systems to perform computations in a relatively short period of time. These conventional approaches to statistical analysis are typically based on determining particular quantities or values (e.g., mean, median, mode percent change). These values may be used for analysis of past events and/or performances. While these values may be useful for characterizing past results, the values usually provide little to no insight for future performance. Additionally, these values may not readily present correlations between computed data. Translating computed values of past performance into charts or graphs may be one means of conveying results visually.

Conventional systems and methods employ many types of modeling techniques and statistical tools for correlating data. These correlations may be employed for many uses. Identifying correlation relationships between two or more variables is rarely an easy task, as one or more computed results may not provide a clear indication for making a decision. Further, employing the conventional methods for decision making based on processed data may also be difficult. Accordingly, there is a need for a method and apparatus that addresses one or more of the aforementioned drawbacks.

### BRIEF SUMMARY OF THE INVENTION

Disclosed and claimed herein are a method and apparatus for analyzing data to provide decision making information. In one embodiment, a method includes receiving data corresponding to an agent for one or more predictor variables of a model, calculating coefficients of the model based, at least in part, on a logistic regression analysis for a response variable to determine probability densities of the response variable, wherein the response variable is associated with the one or more predictor variables. The method further includes performing a computational analysis of the response variable based on the probability densities of the response variable to determine variation in the probability densities of the response variable. The method further includes generating a decision matrix, reflecting probabilities of one or more response variables and analysis values.

Other aspects, features, and techniques of the invention will be apparent to one skilled in the relevant art in view of the following detailed description of the invention.

### BRIEF DESCRIPTION OF THE DRAWINGS

FIG. 1 depicts a process for providing decision making information according to one embodiment of the invention;

FIG. 2 depicts a simplified block diagram of analysis tool according to one embodiment of the invention;

FIG. 3 depicts a graphical representation of regression analysis according to one embodiment of the invention;

FIG. 4 depicts a process according to one embodiment of the invention;

FIG. 5 depicts a process for creating a model according to one embodiment of the invention;

FIG. 6 depicts a process for providing decision making information according to one embodiment of the invention;

FIG. 7 depicts a graphical representation of a visual display based on results of a Monte Carlo simulation according to one embodiment of the invention;

FIG. 8 depicts a graphical representation of decision matrix according to one embodiment of the invention;

FIG. 9 depicts a user process according to one embodiment of the invention;

FIG. 10 depicts a process for selecting investments according to one or more embodiments of the invention; and

FIG. 11 depicts a process for loan selection according to one embodiment of the invention.

### DETAILED DESCRIPTION OF EXEMPLARY EMBODIMENTS

One aspect of the present invention is directed to analyzing data to provide decision making information. In one embodiment a method may be provided for translating behaviors into a visual decision package. The method may include a combination of statistical predictions, financial (e.g., economic utility) analysis, and game theory to provide a comprehensive decision analysis tool. The method may be based on a model, wherein coefficients of the model may be calculated based on a logistic regression analysis. Probability densities of response variables may be determined, wherein the response variables may be associated with the one or more predictor variables. The method may further include performing a computational analysis, such as a Monte Carlo simulation. In that fashion probability densities of the response variable may be used to determine variation in one or more response variables. The method may include generating a decision matrix using an game theory, wherein probabilities of one or more response variables may be presented with one or more analysis values. In that fashion business decisions and strategies may be determined based on the generated results.

According to another embodiment, a process may be provided for selecting one or more agents or financial instruments based on a threshold value. Selection may be based on a scenario, model and/or user defined attributes. As used herein, an agent may correspond to one or more parties whose actions may be employed in one or more of the logistic regression analysis, computational analysis and modeling.

When implemented in software, the elements of the invention are essentially the code segments to perform the necessary tasks. The program or code segments can be stored in a processor readable medium. The “processor readable medium” may include any medium that can store or transfer information. Examples of the processor readable medium include an electronic circuit, a semiconductor memory device, a ROM, a flash memory or other non-volatile memory, a floppy diskette, a CD-ROM, an optical disk, a hard disk, a fiber optic medium, etc. The code segments may be downloaded via computer networks such as the Internet, Intranet, etc.

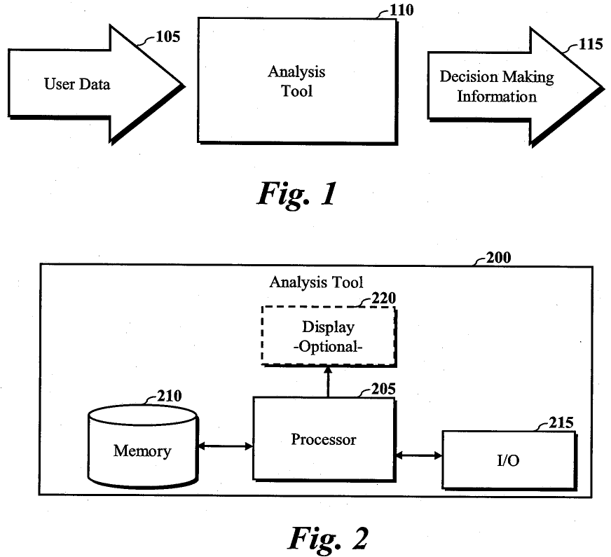

Referring now to the drawings, FIG. 1 illustrates a process for providing decision making information according to one or more embodiments of the invention. As shown in FIG. 1, analysis tool 110 provides decision making information 115 based on user data 105. In one embodiment, analysis tool 110 determines decision making information 115 using one or more of a statistical regression analysis, behavior prioritization, probability based performance and financial analysis, game theory, and computational analysis, such as Monte Carlo simulations. In that fashion, one or more behaviors may be translated into a graphical decision package which may be used for business decisions, strategy and decisions in general. Decision making information 115 may be determined based on categorical response information and numerical predictors. In one embodiment, analysis tool 110 may be used to build a model for describing changes to responses of a dependent variable to the change in value of one or more independent variables.

According to another embodiment, analysis tool 110 may be employed for providing predictive analysis information based on statistical predictions, financial analysis and/or game theory. Analysis tool 110 may be used for one or more applications, such as a payment default predictor, marketable opportunities, billing defaults, subscription services, mortgage loan servicing, internet associations (e.g., dating sites), donation fundraising, markets segmentation analysis, portfolio management, strategic innovation analysis, etc. To that end, analysis tool 110 may provide decision making information 115 for one or more applications. Decision making information 115 may be provided to a user of analysis tool 110 as a graphical image, graphical diagram and/or printed output.

Referring now to FIG. 2, a simplified block diagram is shown of the analysis tool of FIG. 1 according to one embodiment of the invention. As shown in FIG. 2, analysis tool 200 (e.g., analysis tool 110) includes a processor 205 coupled to memory 210 and input/output (I/O) interface 215. Processor 205 may be configured to execute one or more code segments to provide decision making information (e.g., decision making information 115). Processor 205 can be any type of processor such as a microprocessor, field programmable gate array (FPGA) and/or application specific integrated circuit (ASIC). Data received by analysis tool 200 and/or executable code segments utilized by processor 205 may be stored in memory 210. Memory 210 may relate to one of a ROM and RAM memory.

I/O interface 215 of analysis tool 200 may be configured to receive and/or output data. For example, a user may employ I/O interface 215 to provide data which may be utilized by processor 205 to determine decision making information. Analysis tool 200 may further include optional display 220 for outputting decision making information. It may also be appreciated that analysis tool 200 may be coupled to an external display (not shown) by I/O interface 215.

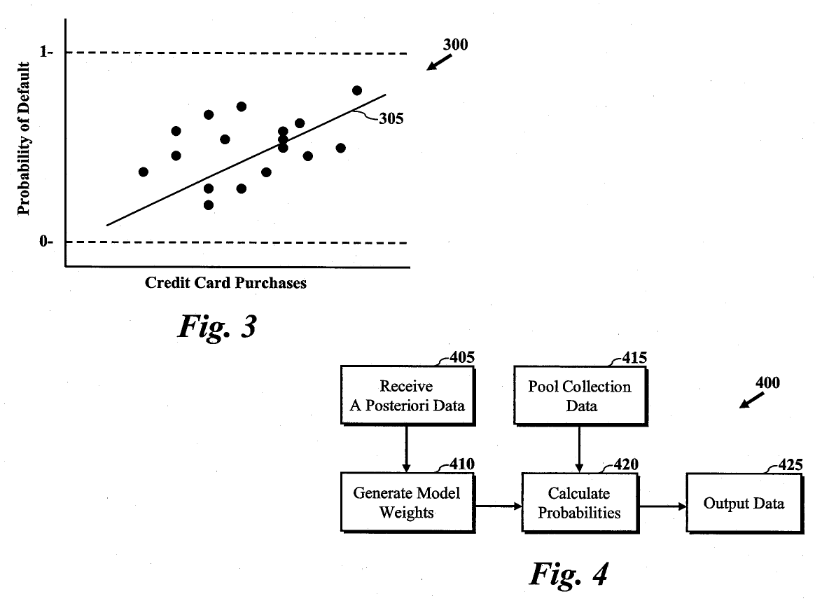

Referring now to FIG. 3, a graphical illustration is shown of the results of an exemplary logistic regression analysis according to one embodiment of the invention. In one embodiment of the invention, a model may be used to describe changes in the response of a dependent variable to the change in value of one or more independent variables. By way of example, the logistic regression of FIG. 3 provides an odds ratio that describes the likelihood of the occurrence of a dependent variable (mortgage default in FIG. 3) based on changes in an independent variable (credit card purchases in FIG. 3). In the logistic regression of FIG. 3, the dependent variable is dichotomous and treated as a probability. It may also be appreciate that a plurality of outcomes may be predicted. According to one embodiment of the invention, logistic regression employed by the invention may be used to predict an outcome for an individual case using the most efficient model.

Referring now to FIG. 4, a process is shown according to one embodiment of the invention. Process 400 may be executed by an analysis tool (e.g., analysis tool 110) to provide decision making information (e.g., decision making information 115) for one or more scenarios. Process 400 may be employed to calculate probability statistics which may be useful in predicting a response variable.

According to one embodiment, process 400 may be utilized to analyze scenarios wherein two or more agents are making decisions. For example, a mortgage scenario where one agent is a lender and another agent is the mortgage holder. Further, process 400 may be employed to determine the likelihood of the occurrence of a dependent variable (e.g., mortgage default in FIG. 3) based on changes in an independent variable (credit card purchases in FIG. 3). Further, process 400 may be used to determine probability statistics based on some form of marginal utility, where the marginal utility of one of the agents is indeterminable, except by analysis of a posteriori information. Thus, process 400 receives a posteriori data at block 405. In one embodiment, when process 400 is employed for determining probabilities associated with a mortgage loan, a posteriori data received in block 405 may comprise borrower action data, and/or lender action data. A posteriori data received at block 405 can relate to data dependent on a scenario predicted. Data received at block 405 may include a plurality of fields.

Based on a posteriori data received at block 405, logistic regression modeling may be used to generate model weights at block 410. Creation of a model may be initiated by assuming that the conditional expectation of a dependent variable or response variable Y is equal to a linear combination of independent variables and coefficients X^{t}β such that:

Y=X^{T}β+ε Equation 1

where ε is a general error term.

Based on the business application the model will address, the response variable Y is discrete following the binomial distribution. A binomial distribution may be described where Y is the number of successes, n is the number of trials and n is the probability of success:

$$Bin ( y ; n , π ) = ( \begin{matrix}n \\ y\end{matrix} ) {{π}^{y} ( 1 - π )}^{n - y} \qquad Equation 2$$

The link function for the binomial distribution is the logit function, that is unknown probabilities for the response variable Y modeled as a linear function of independent variables X. The logit function for the binomial distribution may be described as:

$$\begin{matrix}logit ( π ) = ln ( \frac{π}{1 - π} ) \\ = {β}_{0} + {β}_{1} {x}_{1 , i} + {β}_{2} {x}_{2} + … + {β}_{k} {x}_{k , i} \\ = g ( E [ {Y}_{i} ] )\end{matrix} \qquad Equation 3$$

Model weights may relate to coefficients described in equation III. At block 415, data may be collected based on the scenario modeled. For example, data collected at block 415 may include loan pool data, economic condition data, demographic data and investment cost. Based on model weights generated at block 410 and data collected at block 415, probabilities may be calculated for each response at block 420. Coefficients of the model, variation around the coefficients, and variations around the independent variables may be used to calculate probability responses for various responses of the dependent variable at block 420. Calculating probabilities at block 420 may include by determining a second order log likelihood of coefficients in equation 4.

$$\begin{matrix}\begin{matrix}{l}^{″} ( β ) = \frac{{\partial }^{2} l ( β )}{\partial ( {β}_{k , j} ) \partial ( {β}_{{k}^{′} , {j}^{′}} )} \\ = {\sum }_{i = 1}^{N} {n}_{i} {x}_{i , k} {π}_{i , j} {π}_{i , {j}^{′}} {x}_{i , {k}^{′}}\end{matrix} & {j}^{′} \neq j\end{matrix} \qquad Equation 4$$

The standard error of the coefficients may be determined by taking the square root of the inverse of the second order log-likelihood of coefficients equation 5.

$$S . E . ( β ) = \sqrt{\frac{1}{\vert {l}^{″} ( β ) \vert}} \qquad Equation 5$$

The probability of a response of each variable thus may be described by equations 6-8.

$$\begin{matrix}π ( y = 2 \vert x ) = \frac{{e}^{{β}_{0} + {β}_{1} {x}_{1 , 2} + {β}_{2} {x}_{2 , 2} + … + {β}_{k} {x}_{k , 2}}}{\begin{matrix}1 + {e}^{{β}_{0} + {β}_{1} {x}_{1 , 1} + {β}_{2} {x}_{2 , 1} + … + {β}_{k} {x}_{k , 1}} + \\ {e}^{{β}_{0} + {β}_{1} {x}_{1 , 2} + {β}_{2} {x}_{2 , 2} + … + {β}_{k} {x}_{k , 2}} + \\ {e}^{{β}_{0} + {β}_{1} {x}_{1 , i} + {β}_{2} {x}_{2 , i} + … + {β}_{k} {x}_{k , i}}\end{matrix}} & Equation 6 \\ π ( y = 1 \vert x ) = \frac{{e}^{{β}_{0} + {β}_{1} {x}_{1 , 1} + {β}_{2} {x}_{2 , 1} + … + {β}_{k} {x}_{k , 1}}}{\begin{matrix}1 + {e}^{{β}_{0} + {β}_{1} {x}_{1 , 1} + {β}_{2} {x}_{2 , 1} + … + {β}_{k} {x}_{k , 1}} + \\ {e}^{{β}_{0} + {β}_{1} {x}_{1 , 2} + {β}_{2} {x}_{2 , 2} + … + {β}_{k} {x}_{k , 2}} + \\ {e}^{{β}_{0} + {β}_{1} {x}_{1 , i} + {β}_{2} {x}_{2 , i} + … + {β}_{k} {x}_{k , i}}\end{matrix}} & Equation 7 \\ π ( y = i \vert x ) = \frac{1}{\begin{matrix}1 + {e}^{{β}_{0} + {β}_{1} {x}_{1 , 1} + {β}_{2} {x}_{2 , 1} + … + {β}_{k} {x}_{k , 1}} + \\ {e}^{{β}_{0} + {β}_{1} {x}_{1 , 2} + {β}_{2} {x}_{2 , 2} + … + {β}_{k} {x}_{k , 2}} + \\ {e}^{{β}_{0} + {β}_{1} {x}_{1 , i} + {β}_{2} {x}_{2 , i} + … + {β}_{k} {x}_{k , i}}\end{matrix}} & Equation 8\end{matrix}$$

In the logistic regression, it may generally be assumed that variables are independently distributed (i.e., cases are independent), and the distribution of Yᵢ is Bin (nᵢ, nᵢ) (i.e., binary logistic regression assumes binomial distribution of the response), and that there is a linear relationship between the logit of the independent variables and the response. Further, in the logistic regression homogeneity of the variance does not need to be satisfied, while errors need not normally be distributed but must be independent. While the foregoing equations are described as calculating probabilities of expectation of a dependent variable, it may be appreciated that other equations may be employed or incorporated.

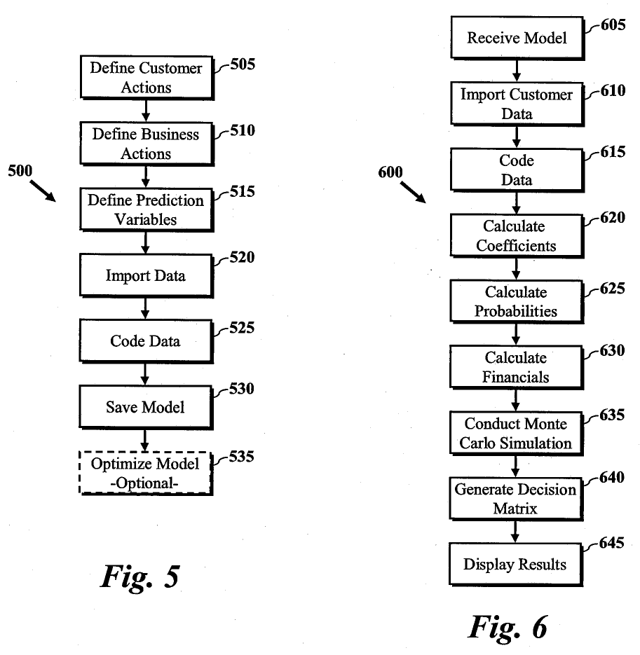

At block 425, calculated probabilities may be output for further analysis. As will be described below in more detail with respect to FIG. 6, calculated probabilities may be employed to perform a Monte Carlo analysis.

Referring now to FIG. 5, a process is shown which may be executed by a user to create a model using the analysis tool of FIG. 1. Process 500 may be initiated by defining customer actions at block 505. Customer actions may relate to one or more dichotomous actions which may be performed by a customer according to a scenario to be modeled. For example, a customer action may relate to loan default by a customer. It may also be appreciated that customer actions may relate to one or more of payment default predictor, marketable opportunities, billing defaults, subscription services, mortgage loan servicing, internet associations (e.g., dating sites), donation fundraising, markets segmentation analysis, portfolio management, strategic innovation analysis, etc. Further, customer actions defined at block 505 may be dependent variables which may be used for regression analysis.

At block 510, business actions may be defined for the model. In one embodiment, business actions may correspond to one or more actions which may be performed by a business associated with customer actions defined at block 505. Prediction variables may be defined at block 515 including but not limited to loan-to-value (LTV), combined loan-to-value (cLTV) and/or debt to income ratio (DTI).

At block 520, data may be imported by the analysis tool. The analysis tool may code data at block 525. Coding data can include assigning a sequential number to an attribute or test data. The number may be assigned based on the variables contributed to the response. For example, a simple model can be used to relate change to a categorical response or dependent variable to the change of an ordered input or independent variable. As such, data may be partitioned for processing by a field. Further at block 525, a model may be created based on a logistic regression according to one or more embodiments of the invention and as described above in FIG. 4. At block 530, the model may be saved by the analysis tool for later use.

Process 500 may further include the optional act of optimizing the model in block 535. Model optimization may be based on specific scenarios which may be modeled and or correcting a particular model. The model may be optimized to include additional and/or different actions performed by an agent.

Referring now to FIG. 6, process 600 is shown for providing decision making information according to one embodiment of the invention. As shown in FIG. 6, process 600 may be initiated by receiving a model at block 605. A user may select a previously generated model for testing a particular scenario on the analysis tool (e.g., analysis tool 110). Customer data may be imported at block 610 based on the report to be generated. The analysis tool may provide a viewable entry form, or graphical user interface, which may be used by a user to enter customer data.

At block 615, received customer data may be coded by the analysis tool for application to the selected model. Based on coded data at block 615, coefficients may be calculated for the model at block 620. Probabilities of one or more responses or dependent variables may be calculated at block 625 by analysis tool. Financials may then be calculated at block 630. By way of example, the analysis tool can calculate net present value (NPV) based on the model results and likely net outcomes using a traditional method of discounting cash flow over a user defined time horizon additionally taking into account the likelihood of responses at each time frame. The analysis tool can display one or more of a calculated NPV, adjusted NPV and likely NPV for one or more outcomes modeled by the analysis tool. It may also be appreciated that financials calculated at block 630 may correspond to other quantities and/or indicators and is not limited to NPV.

A Monte Carlo simulation may be conducted at block 635 based on the calculated financials. In one embodiment, the Monte Carlo analysis may be carried out by defining a distribution (Φ) of interest around the coefficient and predictor variables. For each distribution, the mean (μ) of the standard deviation (σ) is defined or calculated. A margin of error (d) may also be defined by a user of the analysis tool. Analysis tool may then generate values of the distribution issuing a random number generator such that:

$$\frac{σ}{\sqrt{k}} < d \qquad Equation 9$$

Variation in the probability of the response variables may be calculated using the Monte Carlo analysis by the analysis tool. The probability of each of the response variables then forms a distribution with a center and a variance. The probabilities of the response variables are mutually exclusive.

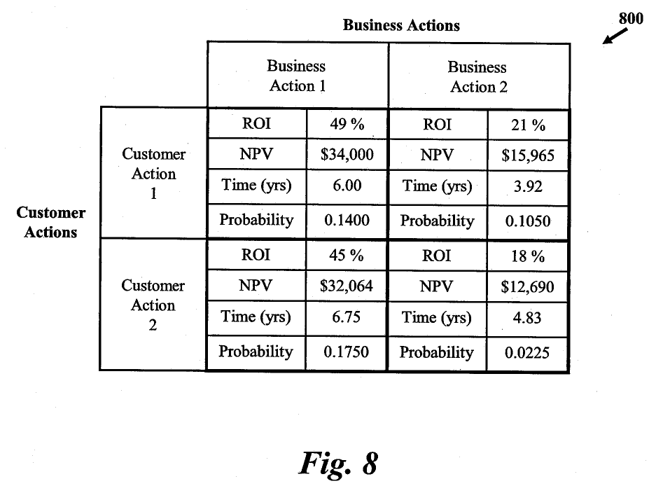

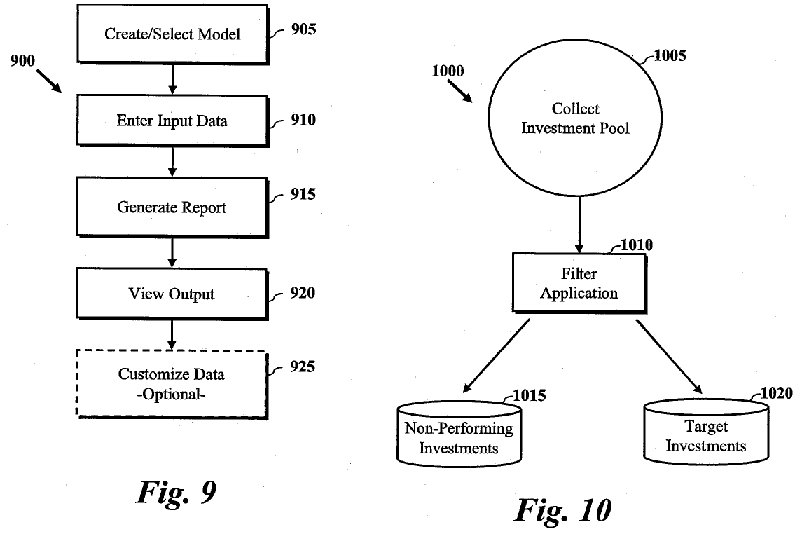

The probabilities of the response variables are then provided in a decision matrix as a stand in for the marginal utility obtained by one of the agents. Marginal utility can generally express many tangible and intangible factors that may be difficult to quantify. Thus, an advantage of the process performed by the analysis tool in process 600 is that likely responses based on a posteriori information may be used as marginal utility (e.g., the frequency of action that an agent has taken in the past are the marginal utilities of those actions). A decision matrix is generated at block 640 containing the marginal utilities. The decision matrix is described below in more detail with reference to FIG. 8.

Results of the report may be displayed for a user of the analysis tool at block 645. Based on results displayed by a user of the analysis tool, one or more decisions may be made. It should also be appreciate that additional reports may be generated by an analysis tool as a result of one or more acts of process 600.

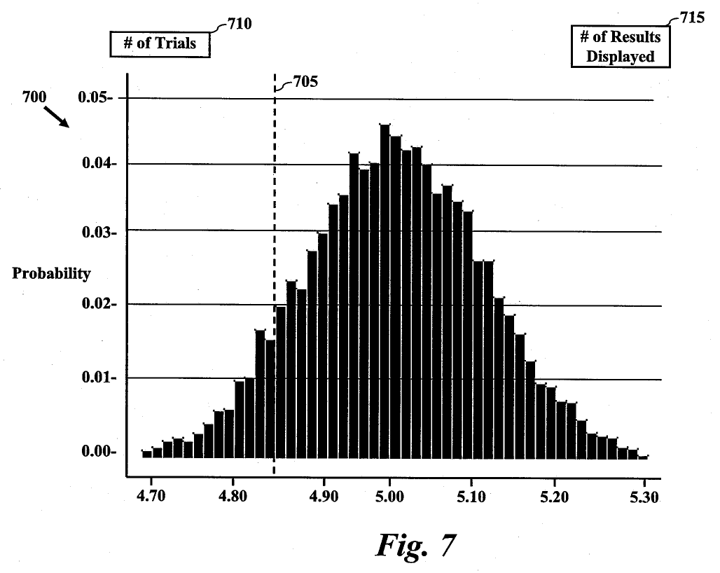

Referring now to FIG. 7, a graphical illustration is shown of a distribution generated by a Monte Carlo simulation. Distribution 700 provides the probability of response variables. Analysis tool may generate distribution 700 based on a Monte Carlo simulation of probabilities calculated by a model of a scenario. Distribution 700 illustrates an expected NPV at a bid price as generated by an analysis tool. The Monte Carlo simulation may be based on a user specified number of trials and user specified number of results displayed. According to another embodiment, the analysis tool can display an acceptability threshold 705 which may be employed to generate decision making information. Similarly, the analysis tool can further display the number of trials 710 and number of results displayed 715.

Referring now to FIG. 8, a graphical representation of a decision matrix is shown according to one or more embodiments. Decision matrix 800 may be generated by the analysis tool of FIG. 1 according to one embodiment. Decision matrix 800 provides customer economic utility behaviors against business process decisions. Decision matrix 800 may be displayed and/or printed for a user of analysis tool to determine if an investment should be pursued by a business based on potential customer actions. To that end, the analysis tool may provide decision making information based on statistical prediction, financial analysis and game theory.

Referring now to FIG. 9, a process is shown which may be performed by a user operating the analysis tool of FIG. 1. Process 900 may be initiated by the user creating and/or selecting a model to be employed at block 905. The analysis tool (e.g., analysis tool 110) may store one or more models for future use by a user. For example, a user may create or select a model to predict a mortgage default rate of an individual loan. The user may further specify actions to be modeled associated with actions which an agent may take using the analysis tool. At block 910, the user can input data for a scenario to be tested. The user may input data corresponding to a particular loan. The analysis tool may allow the user to select a particular loan by an identifier. The user may then generate a report at block 915. The analysis tool can generate a report based on the model selected at block 905, data input at block 910 and determine probability of one or more actions by the customer and/or business. For example, the analysis tool can indicate the probability of a customer action based on a business action, such as mortgage default based on increase in loan rate.

At block 920, the user can view output of the analysis tool for making a decision associated with the scenario modeled. For example, the analysis tool may be used to analyze a mortgage loan for resale. According to another embodiment, process 900 may be performed by an analysis tool to provide an estimate of a value, such as a loan purchase price. Process 900 may further include the optional act of customizing data for the scenario modeled at block 925.

Referring now to FIG. 10, a process is shown for selecting investments according to one embodiment of the invention. Process 1000 may be performed by the analysis tool of FIG. 1 to select investments based on statistical analysis and a Monte Carlo simulation. Process 1000 may be initiated collecting investments into an investment pool 1005. The analysis tool (e.g., analysis tool 110) may include a filter application 1010 to select investments based on one or more user criteria. For example, investment criteria may correspond to a predicted loan default rate exceeding a set value. Based on filter application 1010 the analysis tool can separate the investment pool into non-performing investments 1015 and target investments 1020. An advantage of the process 1000 may be to identify target investments 1020 which meet a predefined threshold.

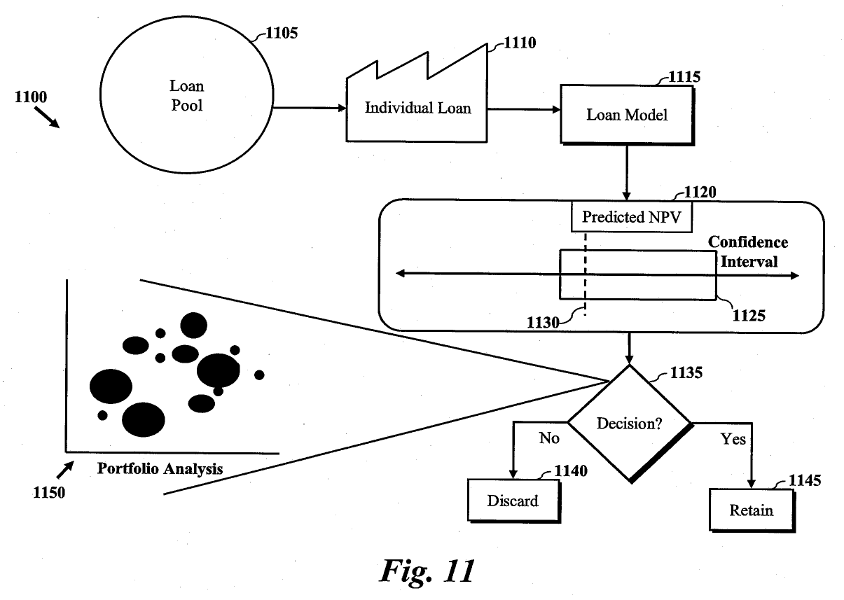

Referring now to FIG. 11, a process is shown for selecting loans according to one or more embodiments of the invention. Process 1100 is shown for selecting loans based on a loan model and determination of a predicted net present value (NPV). While process 1100 is described as relating to valuation of a loan based in part on net present value it should equally be appreciated that other investments types and/or or values may be used as a similar analysis. Process 1100 may be performed by an analysis tool (e.g., analysis tool 110). Loan pool 1105 may be accessed and individual loan 1110 may be selected. Loan model 1115 may be selected for predicting the NPV of loan 1110. The analysis tool may then determine the predicted NPV 1120 including a confidence interval 1125 and threshold 1130.

Based on the predicted NPV 1120, the analysis tool may then perform a decision making step at block 1135. When the predicted NPV is below a user selected threshold (“No” path out of decision block 1135), the analysis tool can indicate that the individual loan is below the threshold at block 1140. When the predicted NPV is acceptable based on the user selected threshold (“Yes” path out of decision block 1135), the analysis tool can indicate that the individual loan is below the threshold at block 1145. It may also be appreciated that the analysis tool can provide one or more graphical representations 1150 of the individual loan for analysis of one or more loans.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other modifications may occur to those ordinarily skilled in the art. Trademarks and copyrights referred to herein are the property of their respective owners.

What is claimed is:

1. A method for analyzing data to provide decision making information, the method comprising the acts of:
receiving data for one or more predictor variables of a model, the data corresponding to an agent;
calculating coefficients of the model based, at least in part, on a logistic regression analysis for a response variable to determine probability densities of the response variable, wherein the response variable is associated with the one or more predictor variables;
performing a computational analysis of the response variable based on the probability densities of the response variable to determine variation in the probability densities of the response variable; and
generating a decision matrix, reflecting probabilities of one or more response variables and analysis values.

2. The method of claim 1, wherein the predictor variables correspond to categorical response information.

3. The method of claim 1, wherein the response variable corresponds to a possible action taken by the agent.

4. The method of claim 1, wherein the computational analysis is a Monte Carlo simulation using an expected value and variance of calculated coefficients.

5. The method of claim 1, wherein decision matrix is generated using game theory.

6. The method of claim 1, wherein the analysis values correspond to calculated business data, such as one or more of return on investment (ROI), net present value (NPV) and business calculations in general.

7. The method of claim 1, wherein a model may be built using logistic regression to describe change in response to a dependent variable to change in one or more independent variables.

8. The: method of claim 1, wherein decision matrix comprises a first and second axis, the first axis of the decision matrix presenting the probabilities of one or more response variables, and the second axis of the decision matrix presenting one or more of the analysis values.

9. The method of claim 1, further comprising receiving data for a plurality of agents and selecting one or more of the agents based on one or more results of the computational analysis for an agent and a predefined threshold.

10. The method of claim 1, wherein the decision making relates to one or more of predicting payment default, property appraisal, marketable opportunities requiring decisions around economic utility behaviors, billing defaults, subscription services, mortgage loan servicing, internet associations, donation fundraising, market segmentation analysis, portfolio management, and strategic innovation analysis.

11. A computer program product comprising:
a computer readable medium having computer executable program code embodied therein for analyzing data to provide decision making information, the computer executable program product having;
computer executable program code to receive data for one or more predictor variables of a model, the data corresponding to an agent;
computer executable program code to calculate coefficients of the model based, at least in part, on a logistic regression analysis for a response variable to determine probability densities of the response variable, wherein the response variable is associated with the one or more predictor variables;
computer executable program code to perform a computational analysis of the response variable based on the probability densities of the response variable to determine variation in the probability densities of the response variable; and
computer executable program code to generate a decision matrix wherein a first axis of the decision matrix contains probabilities of one or more response variables and a second axis of the decision matrix contains one or more analysis values.

12. The computer program product of claim 11, wherein the predictor variables correspond to categorical response information.

13. The computer program product of claim 11, wherein the response variable corresponds to a possible action taken by the agent.

14. The computer program product of claim 11, wherein the computational analysis is a Monte Carlo simulation using an expected value and variance of calculated coefficients.

15. The computer program product of claim 11, wherein decision matrix is generated using game theory.

16. The computer program product of claim 11, wherein the analysis values correspond to calculated business data, such as one or more of return on investment (ROI), net present value (NPV) and business calculations in general.

17. The computer program product of claim 11, wherein a model may be built using logistic regression to describe change in response to a dependent variable to change in one or more independent variables.

18. The computer program product of claim 11, wherein decision matrix comprises a first and second axis, the first axis of the decision matrix presenting the probabilities of one or more response variables, and the second axis of the decision matrix presenting one or more of the analysis values.

19. The computer program product of claim 11, further comprising computer executable program code to receive data for a plurality of agents and computer executable program code to select one or more of the agents based on one or more results of the computational analysis for an agent and a predefined threshold.

20. The computer program product of claim 11, wherein the decision making relates to one or more of predicting payment default, property appraisal, marketable opportunities requiring decisions around economic utility behaviors, billing defaults, subscription services, mortgage loan servicing, internet associations, donation fundraising, market segmentation analysis, portfolio management, and strategic innovation analysis.

21. A method for analyzing data to provide decision making information, the method comprising the acts of:
receiving data for one or more predictor variables of a model, the data corresponding to an agent;
calculating coefficients of the model based, at least in part, on a logistic regression analysis for a response variable to determine probability densities of the response variable, wherein the response variable is associated with the one or more predictor variables;
performing a computational analysis of the response variable based on the probability densities of the response variable to determine variation in the probability densities of the response variable; and
outputting a list of one or more agents based on one or more results of the computational analysis and a predefined threshold.

22. The method of claim 21, wherein the agent relates to one or more of a property appraisal, marketable opportunities requiring decisions around economic utility behaviors, billing defaults, subscription services, mortgage loan servicing, internet associations, donation fundraising, market segmentation analysis, portfolio management, and strategic innovation analysis.
